(19) United States
(12) Patent Application Publication
(10) Pub. No.: US 2022/0020534 A1
(43) Pub. Date: Jan. 20, 2022

(54) CERAMIC ELECTRONIC COMPONENT AND METHOD OF MANUFACTURING THE SAME

(71) Applicant: TAIYO YUDEN CO., LTD., Tokyo (JP)

(72) Inventors: Shunya FUKUDA, Tokyo (JP); Fukio KINOSHITA, Tokyo (JP); Daisuke IWAI, Tokyo (JP)

(73) Assignee: TAIYO YUDEN CO., LTD., Tokyo (JP)

(21) Appl. No.: 17/370,988

(22) Filed: Jul. 8, 2021

(30) Foreign Application Priority Data
Jul. 16, 2020 (JP) 2020-121926

(51) Int. Cl. H01G 4/30; H01G 4/248; H01G 4/012

(52) U.S. Cl. CPC H01G 4/30; H01G 4/012; H01G 4/248

(57) ABSTRACT

A ceramic electronic component includes a multilayer chip including a multilayer structure having ceramic dielectric layers and internal electrode layers alternately stacked, and cover layers respectively disposed on top and bottom faces of the multilayer structure in a first direction in which the dielectric layers and the internal electrode layers are stacked, and a pair of external electrodes formed from respective edge faces to at least one side face of the multilayer chip, wherein a ratio of a thickness of the multilayer chip in the first direction to a width of the multilayer chip in a shorter side direction is 0.7 or less, wherein a thickness of a capacitance section where adjacent internal electrode layers connected to different external electrodes are opposite to each other in the first direction is equal to or greater than 2.2 times at least one of thicknesses of the cover layers in the first direction.

### FIELD

A certain aspect of the present disclosure relates to a ceramic electronic component and a method of manufacturing the same.

### BACKGROUND

Ceramic electronic components such as multilayer ceramic capacitors have a multilayer chip and a pair of external electrodes formed from respective edge faces opposite to each other of the multilayer chip to at least one of side faces of the multilayer chip. In the multilayer chip, dielectric layers and internal electrode layers are alternately stacked and the internal electrode layers are formed so as to be alternately exposed to the two edge faces. For example, in the multilayer ceramic capacitor, the quality of the electric connection between the internal electrode layers and the external electrodes affects the capacitance as disclosed in Japanese Patent Application Publication No. 2006-86400.

### PRIOR ART DOCUMENT

### Related Art Documents

### PATENT DOCUMENTS

Japanese Patent Application Publication No. 2006-86400

### SUMMARY OF THE INVENTION

Because of the shortage of mounting space due to the increasing density and integration of electronic circuits, ceramic electronic components such as multilayer ceramic capacitors are required to be smaller, in particular, lower in height. In the low-height multilayer ceramic capacitor, the number of the stacked internal electrode layers is less than that of the typical multilayer ceramic capacitor. Thus, poor electric connection between the internal electrode layers and the external electrodes largely affects its capacitance.

The present disclosure has an objective of providing a ceramic electronic component and a method of manufacturing the same that can increase the reliability of the electric connection between the internal electrode layers and the external electrodes.

In one aspect of the present disclosure, there is provided a ceramic electronic component including: a multilayer chip having a substantially parallelepiped shape and including a multilayer structure, which includes dielectric layers and internal electrode layers that are alternately stacked, and cover layers respectively disposed on a top face and a bottom face of the multilayer structure in a first direction in which the dielectric layers and the internal electrode layers are alternately stacked, the dielectric layers being mainly composed of ceramic, the internal electrode layers being formed so as to be alternately exposed to two edge faces opposite to each other of the multilayer structure; and a pair of external electrodes formed from the respective edge faces to at least one of side faces of the multilayer chip, wherein a ratio of a thickness of the multilayer chip in the first direction to a width of the multilayer chip in a shorter side direction is 0.7 or less, wherein a thickness of a capacitance section where adjacent internal electrode layers connected to different external electrodes are opposite to each other in the first direction is equal to or greater than 2.2 times at least one of thicknesses of the cover layers in the first direction.

In the above ceramic electronic component, the number of the internal electrode layers that are stacked per 10 μm of thickness of the capacitance section in the first direction may be 1 or greater and 10 or less.

In the above ceramic electronic component, a ratio of the number of the internal electrode layers each having a distance of 1.5 μm or less from a corresponding one of the external electrodes in a second direction to a total number of the internal electrode layers may be 80% or less, the second direction being a direction in which the two edge faces are opposite to each other.

In the above ceramic electronic component, the thickness of the multilayer chip in the first direction may be 0.110 mm or less.

In the above ceramic electronic component, the thickness of the multilayer chip in the first direction may be 0.06 mm or less.

In another aspect of the present disclosure, there is provided a method of manufacturing a ceramic electronic component, the method including: forming a ceramic multilayer structure having a substantially parallelepiped shape by alternately stacking ceramic dielectric green sheets and conductive pastes for internal electrode layers to form a multilayer portion in which the conductive pastes are alternately exposed to two edge faces opposite to each other of the multilayer portion, and disposing a cover layer on each of top and bottom faces of the multilayer portion in a first direction in which the ceramic dielectric green sheets and the conductive pastes are alternately stacked; applying a metal paste from each of two edge faces of the ceramic multilayer structure to at least one of side faces of the ceramic multilayer structure; and firing the metal pastes and the ceramic multilayer structure to form a multilayer chip and a pair of external electrodes formed from respective edge faces of the multilayer chip to at least one of side faces of the multilayer chip, the multilayer chip including a multilayer structure and a cover layer disposed on each of top and bottom faces of the multilayer structure in the first direction, the multilayer structure including dielectric layers and internal electrode layers that are alternately stacked so that the internal electrode layers are alternately exposed to the two edge faces of the multilayer structure, wherein the forming includes adjusting a thickness of the ceramic dielectric green sheet between adjacent conductive pastes for internal electrode layers so that a ratio of a thickness of the multilayer chip in the first direction to a width of the multilayer chip in a shorter side direction becomes 0.7 or less, and a thickness of a capacitance section where adjacent internal electrode layers connected to different external electrodes are opposite to each other in the first direction becomes equal to or greater than 2.2 times at least one of thicknesses of the cover layers in the first direction.

In another aspect of the present disclosure, there is provided a method of manufacturing a ceramic electronic component, the method including: forming a ceramic multilayer structure having a substantially parallelepiped shape by alternately stacking ceramic dielectric green sheets and conductive pastes for internal electrode layers to form a multilayer portion in which the conductive pastes are alternately exposed to two edge faces opposite to each other of the multilayer portion, and disposing a cover layer on each of top and bottom faces of the multilayer portion in a first direction in which the ceramic dielectric green sheets and the conductive pastes are alternately stacked; firing the ceramic multilayer structure to form a multilayer chip including a multilayer structure and a cover layer disposed on each of top and bottom faces of the multilayer structure in the first direction, the multilayer structure including dielectric layers and internal electrode layers that are alternately stacked so that the internal electrode layers are alternately exposed to two edge faces opposite to each other of the multilayer chip; applying a metal paste from each of the two edge faces of the multilayer chip to at least one of side faces of the multilayer chip; and baking the metal pastes to form a pair of external electrodes, wherein the forming includes adjusting a thickness of the ceramic dielectric green sheet between adjacent conductive pastes for internal electrode layers so that a ratio of a thickness of the multilayer chip in the first direction to a width of the multilayer chip in a shorter side direction becomes 0.7 or less, and a thickness of a capacitance section where adjacent internal electrode layers connected to different external electrodes are opposite to each other in the first direction becomes equal to or greater than 2.2 times at least one of thicknesses of the cover layers in the first direction.

### BRIEF DESCRIPTION OF THE DRAWINGS

FIG. 1A is a partial cross-sectional perspective view of a multilayer ceramic capacitor, and FIG. 1B illustrates the multilayer ceramic capacitor as viewed from the top face in the stack direction;

FIG. 2 is a cross-sectional view taken along line A-A in FIG. 1B;

FIG. 3 is a cross-sectional view taken along line B-B in FIG. 1B;

FIG. 4 is a cross-sectional view taken along line A-A in FIG. 1B, and is a diagram for describing the thickness of each section;

FIG. 5A is a cross-sectional view of a multilayer ceramic capacitor in which 10 internal electrode layers are stacked, FIG. 5B and FIG. 5C are cross-sectional views of multilayer ceramic capacitors in which 6 internal electrode layers are stacked;

FIG. 6A is a cross-sectional view taken along line C-C in FIG. 2, and FIG. 6B is a diagram for describing a distance between the internal electrode layer and the external electrode;

FIG. 7 is a flowchart of a method of manufacturing the multilayer ceramic capacitor;

FIG. 8A and FIG. 8B illustrate a stacking process;

FIG. 9 illustrates the stacking process;

FIG. 10 illustrates the stacking process; and

FIG. 11 is a flowchart of another method of manufacturing the multilayer ceramic capacitor.

### DETAILED DESCRIPTION

Hereinafter, a description will be given of an embodiment with reference to the accompanying drawings.

### Embodiment

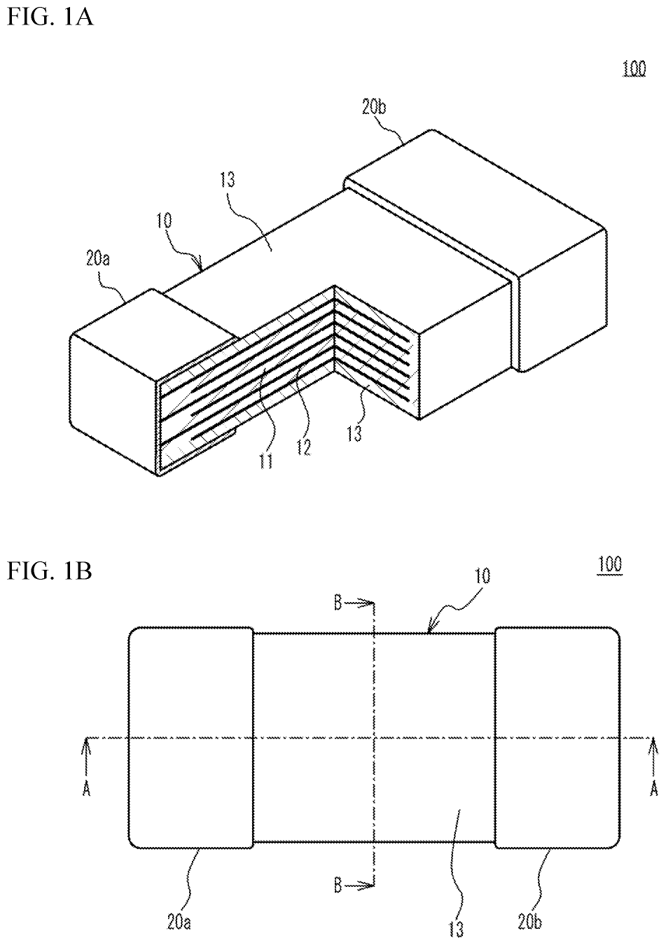

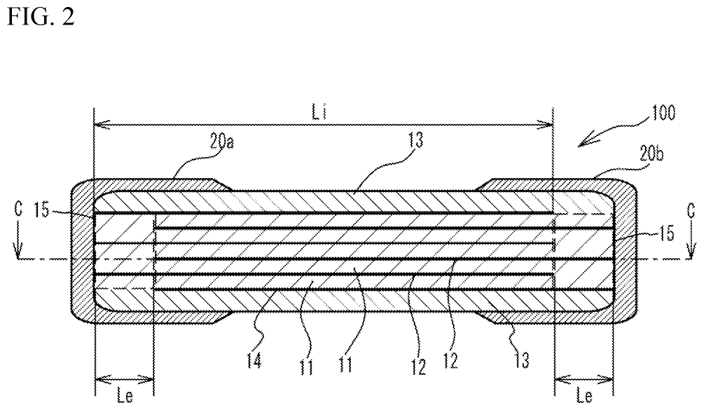

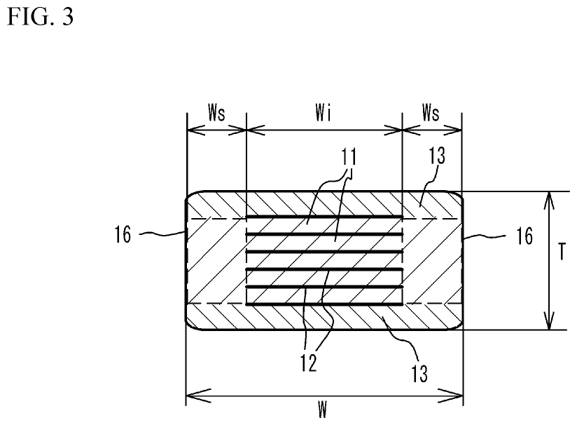

FIG. 1A is a partial cross-sectional perspective view of a multilayer ceramic capacitor 100 in accordance with an embodiment, and FIG. 1B illustrates the multilayer ceramic capacitor 100 as viewed from the top face in the stack direction. FIG. 2 is a cross-sectional view taken along line A-A in FIG. 1B. FIG. 3 is a cross-sectional view taken along line B-B in FIG. 1B.

As illustrated in FIG. 1A to FIG. 3, the multilayer ceramic capacitor 100 includes a multilayer chip 10 having a substantially parallelepiped shape, and external electrodes 20a and 20b disposed on two edge faces opposite to each other of the multilayer chip 10. Among four faces other than the two edge faces of the multilayer chip 10, the faces other than the top face and the bottom face in the stack direction are referred to as side faces. The stack direction (a first direction) is a direction in which dielectric layers 11 and internal electrode layers 12, which are described later, are alternately stacked. Each of the external electrodes 20a and 20b extends from the corresponding edge face to the top and bottom faces in the stack direction and the two side faces of the multilayer chip 10. However, the external electrodes 20a and 20b are spaced from each other.

The multilayer chip 10 has a multilayer structure designed to have the dielectric layers 11 and the internal electrode layers 12 alternately stacked. The dielectric layer 11 contains a ceramic material functioning as a dielectric substance. The internal electrode layer 12 contains a base metal material. End edges of the internal electrode layers 12 are alternately exposed to a first edge face of the multilayer chip 10 and a second edge face of the multilayer chip 10. The external electrode 20a is disposed on the first edge face, while the external electrode 20b is disposed on the second edge face. Therefore, the internal electrode layers 12 are alternately electrically connected to the external electrode 20a and the external electrode 20b. Accordingly, the multilayer ceramic capacitor 100 has a structure in which the internal electrode layers 12 are stacked with the dielectric layers 11 interposed therebetween. In addition, the internal electrode layers 12 are the outermost layers in the stack direction of the multilayer structure formed of the dielectric layers 11 and the internal electrode layers 12. The top face and the bottom face of the multilayer structure are covered with cover layers 13. The cover layer 13 is mainly composed of a ceramic material. For example, the main component of the material of the cover layers 13 is the same as the main component of the ceramic material of the dielectric layer 11.

In the multilayer ceramic capacitor 100, the ratio of the thickness (the height), which is indicated by T in FIG. 3, of the multilayer chip 10 in the stack direction to the width, which is indicated by W in FIG. 3, of the multilayer chip 10 in the shorter side direction is 0.7 or less. More specifically, the multilayer ceramic capacitor 100 may have a length of 0.4 mm, a width of 0.2 mm, and a height of 0.11 mm. The multilayer ceramic capacitor 100 may have a length of 0.4 mm, a width of 0.2 mm, and a height of 0.06 mm. The multilayer ceramic capacitor 100 may have a length of 0.6 mm, a width of 0.3 mm, and a height of 0.2 mm. The multilayer ceramic capacitor 100 may have a length of 1.0 mm, a width of 0.5 mm, and a height of 0.3 mm. The multilayer ceramic capacitor 100 may have a length of 1.0 mm, a width of 0.5 mm, and a height of 0.2 mm. However, the dimensions of the multilayer ceramic capacitor 100 are not limited to the above dimensions.

The main component of the internal electrode layer 12 is a base metal such as nickel (Ni), copper (Cu), tin (Sn), or the like. The internal electrode layer 12 may be made of a noble metal such as platinum (Pt), palladium (Pd), silver (Ag), or gold (Au), or an alloy thereof. The average thickness of each of the internal electrode layers 12 is, for example, 1 μm or less. The dielectric layers 11 are mainly composed of a ceramic material having a perovskite structure expressed by a general expression ABO₃. The perovskite structure includes ABO_{3-α} having an off-stoichiometric composition. For example, employed as the ceramic material is barium titanate (BaTiO₃), calcium zirconate (CaZrO₃), calcium titanate (CaTiO₃), strontium titanate (SrTiO₃), or Ba_{1-x-y}CaₓSr_{y}Ti_{1-z}Zr_{z}O₃ (0≤x≤1, 0≤y≤1, 0≤z≤1) having a perovskite structure.

The main component of the external electrodes 20a and 20b is a metal such as Cu, Ni, aluminum (Al), zinc (Zn), Ag, Au, Pd, or Pt, or an alloy of at least two of them (for example, an alloy of Cu and Ni).

As illustrated in FIG. 2, the section where the internal electrode layer 12 connected to the external electrode 20a is opposite to the internal electrode layer 12 connected to the external electrode 20b is a section where electric capacitance is generated in the multilayer ceramic capacitor 100. Thus, the section where electric capacitance is generated is referred to as a capacitance section 14. That is, the capacitance section 14 is a section where two adjacent internal electrode layers 12 connected to different external electrodes are opposite to each other.

The section where the internal electrode layers 12 connected to the external electrode 20a are opposite to each other with no internal electrode layer 12 connected to the external electrode 20b interposed therebetween is referred to as an end margin section 15. The section where the internal electrode layers 12 connected to the external electrode 20b are opposite to each other with no internal electrode layer 12 connected to the external electrode 20a interposed therebetween is also the end margin section 15. That is, the end margin section 15 is a section where the internal electrode layers 12 connected to one of the external electrodes are opposite to each other with no internal electrode layer 12 connected to the other of the external electrodes interposed therebetween. The end margin section 15 is a section where no electric capacitance is generated. As illustrated in FIG. 2, the length of the internal electrode layer 12 in the direction in which the two edge faces of the multilayer chip 10 are opposite to each other (hereinafter, referred to as the facing direction of the two edge faces (a second direction)) is represented by Li, and the length of the end margin section 15 in the facing direction of the two edge faces of the multilayer chip 10 is represented by Le.

As illustrated in FIG. 3, in the multilayer chip 10, the section from each of the two side faces of the multilayer chip 10 to the internal electrode layers 12 is referred to as a side margin section 16. That is, the side margin section 16 is a section that covers the end edges, extending toward the corresponding side face of the multilayer structure, of the stacked internal electrode layers 12. The side margin section 16 is also a section where no electric capacitance is generated. As illustrated in FIG. 3, the width of the side margin section 16 in the direction in which the two side faces of the multilayer chip 10 are opposite to each other (hereinafter, referred to as the facing direction of the two side faces) is represented by Ws, and the width of the internal electrode layer 12 in the facing direction of the two side faces of the multilayer chip 10 is represented by Wi.

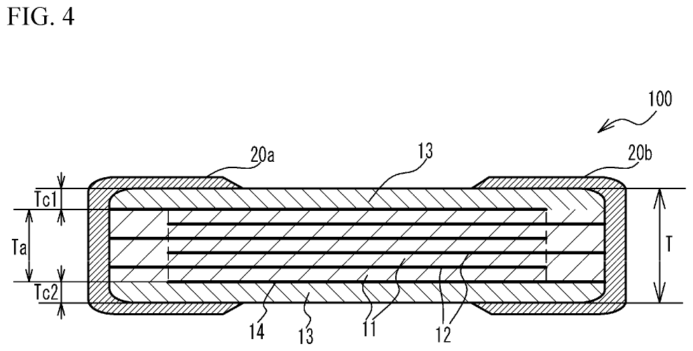

In the multilayer ceramic capacitor 100 of the present embodiment, as illustrated in FIG. 4, the thickness of the capacitance section 14 in the stack direction is represented by Ta, the thickness of one of the cover layers 13 in the stack direction is represented by Tc1, and the thickness of the other of the cover layers 13 in the stack direction is represented by Tc2. In this case, the thickness Ta of the capacitance section 14 in the stack direction is equal to or greater than 2.2 times at least one of the thicknesses Tc1 and Tc2 of the cover layers 13 in the stack direction. The thickness Ta of the capacitance section 14 in the stack direction and the thicknesses Tc1 and Tc2 of the cover layers 13 in the stack direction can be measured in the cross-section orthogonal to the facing direction of the side faces at the center in the length direction (the facing direction of the two edge faces) and the width direction (the facing direction of the two side faces) of the multilayer chip 10. This structure increases the reliability of the electric connection between the internal electrode layers 12 and the external electrodes 20a and 20b. A detailed description will be given of this advantageous effect.

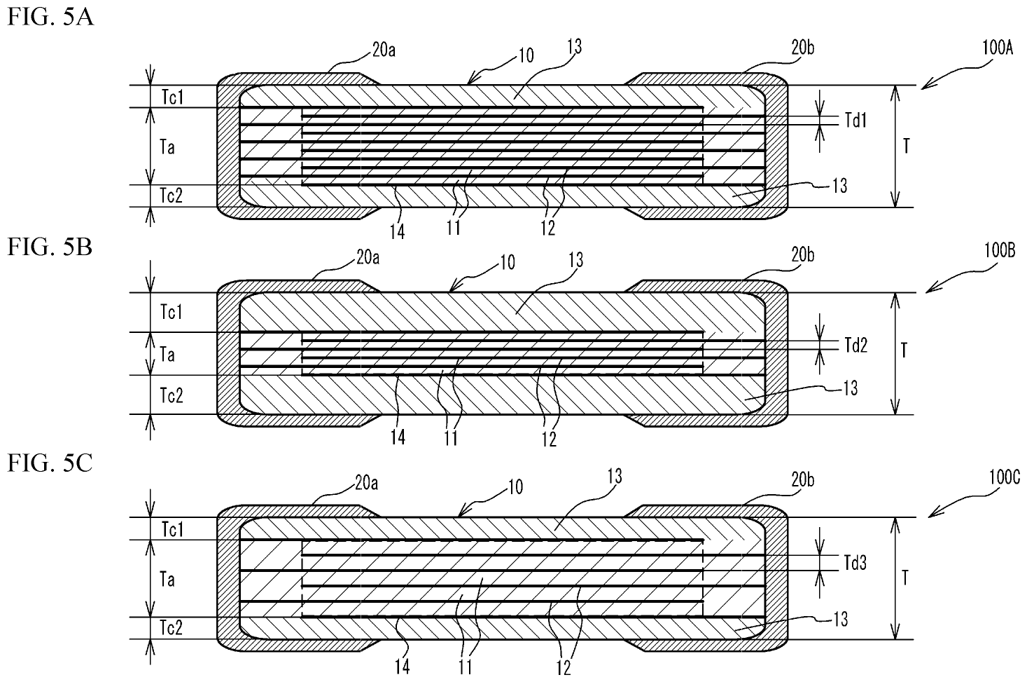

FIG. 5A is a cross-sectional view of a multilayer ceramic capacitor 100A in which 10 internal electrode layers 12 are stacked, and FIG. 5B and FIG. 5C are cross-sectional views of multilayer ceramic capacitors 100B and 100C in which 6 internal electrode layers 12 are stacked, respectively. The cross-sections of FIG. 5A to FIG. 5C correspond to the cross-section taken along line A-A in FIG. 1. The thicknesses T of the multilayer chips 10 of the multilayer ceramic capacitors 100A to 100C in the stack direction are the same.

In the multilayer ceramic capacitor 100B illustrated in FIG. 5B, the thickness Td2 of the dielectric layer 11 between the adjacent internal electrode layers 12 is equal to the thickness Td1 of the dielectric layer 11 in the multilayer ceramic capacitor 100A illustrated in FIG. 5A. The thickness Ta of the capacitance section 14 in the stack direction is less than 2.2 times at least one of the thicknesses Tc1 and Tc2 of the cover layers 13 in the stack direction. In contrast, in the multilayer ceramic capacitor 100C illustrated in FIG. 5C, the thickness Td3 of the dielectric layer 11 between the adjacent internal electrode layers 12 is greater than the thickness Td1 of the dielectric layer 11 in the multilayer ceramic capacitor 100A illustrated in FIG. 5A. Thus, in the multilayer ceramic capacitor 100C illustrated in FIG. 5C, the thickness Ta of the capacitance section 14 in the stack direction is equal to or greater than 2.2 times at least one of the thicknesses Tc1 and Tc2 of the cover layers 13 in the stack direction.

In the case where the number of the stacked internal electrode layers 12 is small, when the internal electrode layers 12 and the dielectric layers 11 having a thickness identical to the thickness of the dielectric layer 11 when the number of the stacked internal electrode layers 12 is large are stacked, the capacitance section 14 is localized in the center part of the multilayer chip 10 as illustrated in FIG. 5B. In this case, during firing, the shapes of the edge faces of the multilayer chip 10 becomes irregular because of difference between the shrinkage of the multilayer portion, in which metal conductive pastes for forming the internal electrode layers 12 and dielectric green sheets for forming the dielectric layers 11 are alternately stacked, and the shrinkage of cover sheets for forming the cover layers 13. This results in defect in electric connection between the internal electrode layers 12 and the external electrodes 20a and 20b, and decrease in capacitance (capacitance missing) are more like to occur.

In contrast, in the multilayer ceramic capacitor 100, which is a so-called low-height multilayer ceramic capacitor, of the present embodiment, the thickness Ta of the capacitance section 14 in the stack direction is equal to or greater than 2.2 times at least one of the thicknesses Tc1 and Tc2 of the cover layers 13 in the stack direction. This structure inhibits the shape of the edge faces of the multilayer chip 10 from becoming irregular due to the difference between the shrinkage of the multilayer portion and the shrinkage of the cover sheet. Therefore, the reliability of the electric connection between the internal electrode layers 12 and the external electrodes 20a and 20b is increased. Here, the low-height multilayer ceramic capacitor is defined as a multilayer ceramic capacitor in which a ratio of the thickness of the multilayer chip 10 in the stack direction to the width of the multilayer chip 10 in the shorter side direction is 0.7 or less.

To further increase the reliability of the electric connection between the internal electrode layers 12 and the external electrodes 20a and 20b, the thickness Ta of the capacitance section 14 in the stack direction of the multilayer chip 10 is preferably equal to or greater than 2.3 times at least one of the thicknesses Tc1 and Tc2 of the cover layers 13 in the stack direction, more preferably equal to or greater than 3.0 times at least one of the thicknesses Tc1 and Tc2 of the cover layers 13 in the stack direction, further preferably equal to or greater than 3.5 times at least one of the thicknesses Tc1 and Tc2 of the cover layers 13 in the stack direction.

In this regard, the ratio of the total thickness of the internal electrode layers 12 (the sum of the thicknesses of the internal electrode layers 12) in the stack direction to the thickness of the capacitance section 14 in the stack direction is preferably 12% or greater, more preferably 16% or greater, further preferably 20% or greater. On the other hand, to reduce the difference between the shrinkage of the capacitance section and the shrinkage of the cover sheets, the ratio of the total thickness of the internal electrode layers 12 in the stack direction to the thickness of the capacitance section 14 in the stack direction is preferably 60% or less, more preferably 40% or less, further preferably 32% or less.

To increase deflective strength, the number of the stacked internal electrode layers 12 per 10 μm of the height of the capacitance section 14 in the stack direction is preferably 1 or greater, more preferably 2 or greater. On the other hand, to reduce the difference between the shrinkage of the capacitance section and the shrinkage of the cover sheets, the number of the stacked internal electrode layers 12 per 10 μm of the height of the capacitance section 14 in the stack direction is preferably 10 or less, more preferably 5 or less.

To reduce the height, the thickness of the multilayer chip 10 in the stack direction is preferably 0.110 mm or less, more preferably 0.06 mm or less.

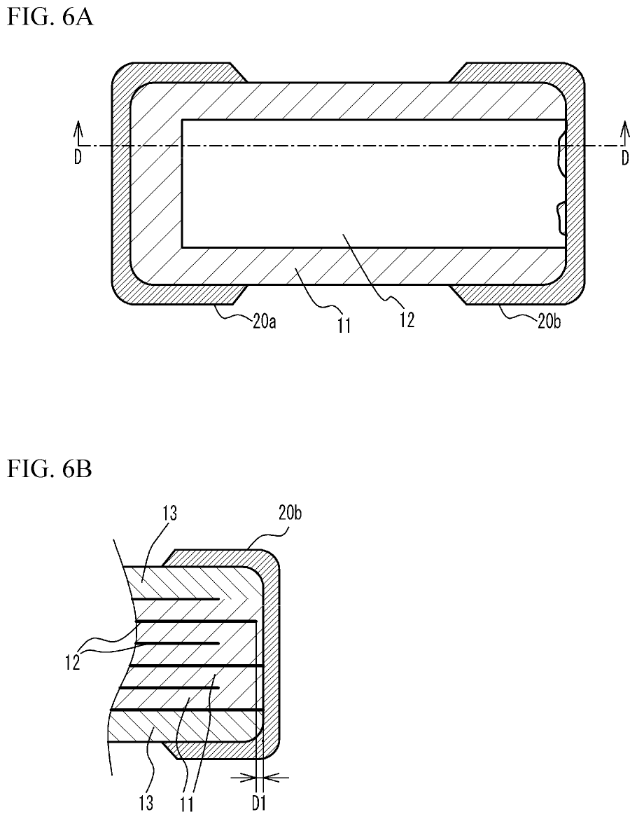

FIG. 6A is a cross-sectional view taken along line C-C in FIG. 2. As illustrated in FIG. 6A, the internal electrode layer 12 may have a part that is not in contact with the external electrode 20b (or the external electrode 20a).

FIG. 6B is a cross-sectional view taken along line D-D in FIG. 6A. In such a cross-section orthogonal to the facing direction of the side faces of the multilayer chip 10, the distance between the internal electrode layer 12 and the external electrode 20b (or 20a) in the facing direction of the two edge faces of the multilayer chip 10 is represented by D1. When the internal electrode layer 12 is in contact with the external electrode 20a or 20b, D1=0. When the internal electrode layer 12 is not in contact with the external electrode 20a or 20b in a certain cross-section, but D1 in such a cross section is 1.5 μm or less, the internal electrode layer 12 is highly likely to be in contact with the external electrode 20a or 20b in other cross-sections (see FIG. 6A). Thus, when the distance D1 between the internal electrode layer 12 and the external electrode 20a or 20b in the facing direction of the two edge faces of the multilayer chip 10 is 1.5 μm or less in a certain cross-section, the internal electrode layer 12 and the external electrode 20a or 20b are considered to be reliably electrically connected. In the multilayer ceramic capacitor 100 of the present embodiment, the ratio (N/Nall) of the number N of the internal electrode layers 12 having a distance D1 of 1.5 μm or less in any cross section to the total number Nall of the internal electrode layers 12 is 80% or greater.

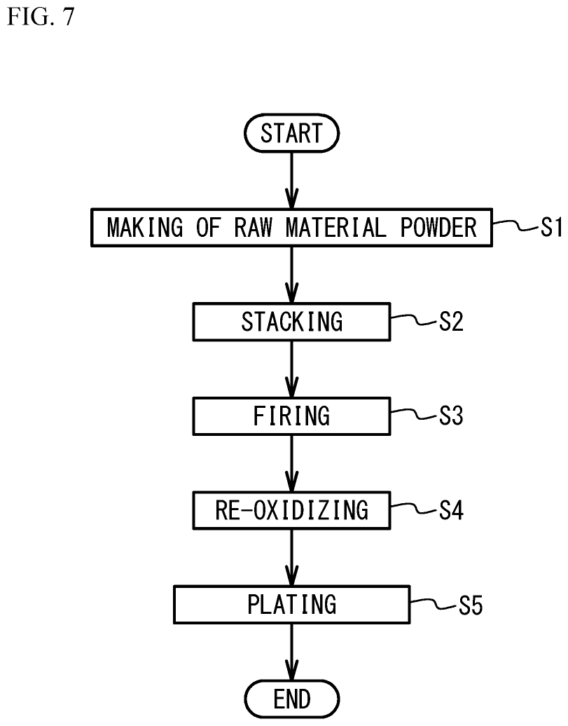

Next, a description will be given of a method of manufacturing the multilayer ceramic capacitor 100 in accordance with the embodiment. FIG. 7 is a flowchart of the method of manufacturing the multilayer ceramic capacitor 100 in accordance with the embodiment. [Making of Raw Material Powder (S1)]

A dielectric material for forming the dielectric layer 11 is prepared. The dielectric material contains the main component ceramic of the dielectric layer 11. The A site element and the B site element contained in the dielectric layer 11 are contained in the dielectric layer 11 typically in the form of a sintered compact of ABO₃ particles. For example, BaTiO₃ is a tetragonal compound having a perovskite structure, and exhibits high permittivity. This BaTiO₃ can be obtained typically by reacting a titanium raw material such as titanium dioxide with a barium raw material such as barium carbonate to synthesize barium titanate. Various methods have been known as a synthesizing method of the main component ceramic of the dielectric layer 11. For example, the solid phase method, the sol-gel method, the hydrothermal method, and the like are known. Any one of the above methods can be employed in the present embodiment.

Additive compound is added to the resulting ceramic powder in accordance with purposes. The additive compound may be an oxide of zirconium (Zr), calcium (Ca), strontium (Sr), magnesium (Mg), manganese (Mn), vanadium (V), chrome (Cr), or a rare-earth element, an oxide of cobalt (Co), Ni, lithium (Li), boron (B), sodium (Na), potassium (K), or silicon (Si), or glass.

Next, a margin material for forming the end margin section 15 and the side margin section 16 is prepared. The margin material contains the main component ceramic of the end margin section 15 and the side margin section 16. For example, BaTiO₃ powder is prepared as the main component ceramic. The BaTiO₃ powder can be obtained through the same process of the making process of the dielectric material. Additive compound is added to the resulting BaTiO₃ powder in accordance with purposes. The additive compound may be an oxide of Zr, Ca, Sr, Mg, Mn, V, Cr, or a rare-earth element, an oxide of Co, Ni, Li, B, Na, K, or Si, or glass.

Next, a cover material for forming the cover layer 13 is prepared. The cover material contains the main component ceramic of the cover layer 13. For example, BaTiO₃ powder is prepared as the main component ceramic. The BaTiO₃ powder can be obtained through the same process as the making process of the dielectric material. Additive compound is added to the resulting BaTiO₃ powder in accordance with purposes. The additive compound may be an oxide of Zr, Ca, Sr, Mg, Mn, V, Cr, or a rare-earth element, an oxide of Co, Ni, Li, B, Na, K, or Si, or glass. The margin material described above may be used as the cover material.

### [Stacking (S2)]

Next, a binder such as polyvinyl butyral (PVB) resin, an organic solvent such as ethanol or toluene, and a plasticizer are added to the resulting dielectric material and wet-blended. With use of the resulting slurry, a strip-shaped dielectric green sheet 51 with a thickness of, for example, 0.8 μm or less is applied on a base material using, for example, a die coater method or a doctor blade method, and then dried.

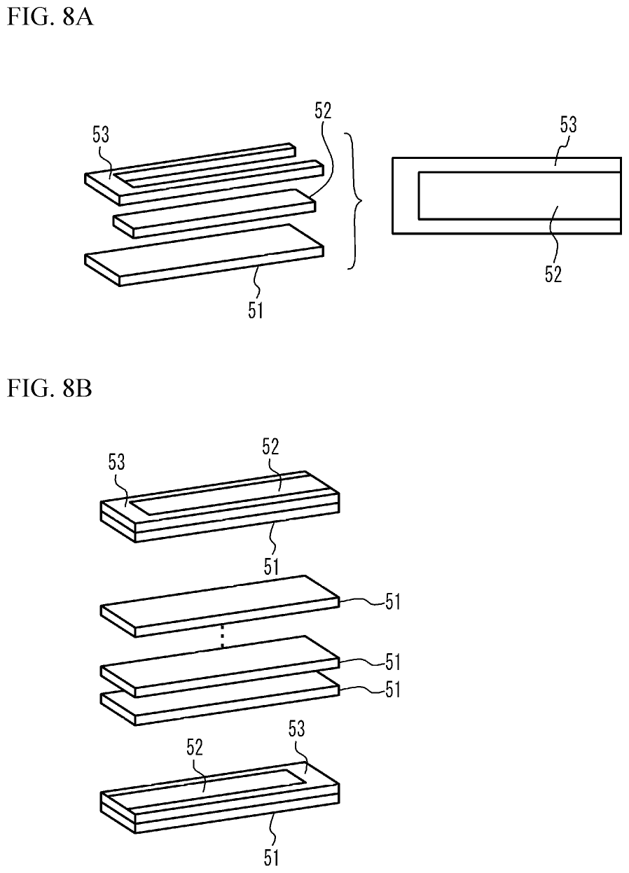

Next, as illustrated in FIG. 8A, a first pattern 52 of the internal electrode layer is formed on the surface of the dielectric green sheet 51 by printing a metal conductive paste for forming the internal electrode with use of screen printing or gravure printing. The metal conductive paste for forming the internal electrode contains an organic binder. Ceramic particles are added as a co-material to the metal conductive paste. The main component of the ceramic particles is not particularly limited, but is preferably the same as the main component ceramic of the dielectric layer 11.

Next, a binder such as an ethylcellulose-based binder and an organic solvent such as a terpineol-based solvent are added to the resulting margin material and kneaded using a roll mill to obtain a margin paste for a reverse pattern layer 17. As illustrated in FIG. 8A, a second pattern 53 is formed by printing the margin paste in the region where no first pattern 52 is printed on the dielectric green sheet 51 so that the second pattern 53 and the first pattern 52 form a flat surface.

Then, as illustrated in FIG. 8B, the dielectric green sheets 51, the first patterns 52, and the second patterns 53 are stacked so that the internal electrode layers 12 and the dielectric layers 11 are alternated with each other and the end edges of the internal electrode layers 12 are alternately exposed to both edge faces in the length direction of the dielectric layer 11 so as to be alternately led out to a pair of external electrodes 20a and 20b of different polarizations. For example, 6 to 30 first patterns 52 are stacked. During this process, the thickness of the dielectric green sheet 51 between the adjacent first patterns 52 is adjusted so that the ratio of the thickness (the height) of the multilayer chip 10 after firing in the stack direction to the width of the multilayer chip 10 after firing in the shorter side direction becomes 0.7 or less, and the thickness Ta of the capacitance section 14 in the stack direction becomes equal to or greater than 2.2 times at least one of the thicknesses (Tc1 and Tc2) of the cover layers 13 in the stack direction. More specifically, the number of the dielectric green sheets 51 interposed between the adjacent first patterns 52 is adjusted.

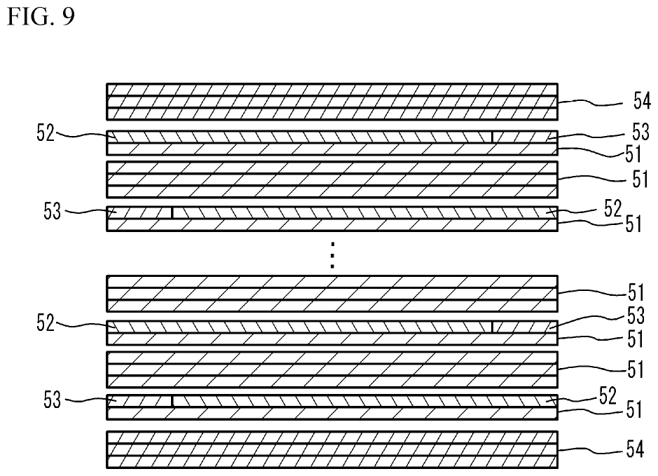

Next, a binder such as a polyvinyl butyral (PVB) resin, an organic solvent such as ethanol or toluene, and a plasticizer are added to the resulting cover material and wet-blended. With use of the resulting slurry, a strip-shaped cover sheet 54 with a thickness of, for example, 10 μm or less is applied on a base material using, for example, a die coater method or a doctor blade method, and is then dried. As illustrated in FIG. 9, a predetermined number (for example, 2 to 10) of the cover sheets 54 are stacked on and under the stacked dielectric green sheets 51, and then heated and compressed. The resulting multilayer structure is cut into a predetermined chip size (for example, 0.4 mm×0.2 mm). Thereafter, metal conductive pastes to be the external electrodes 20a and 20b are applied to the respective edge faces of the cut multilayer structure by dipping and then dried. Through this process, a ceramic multilayer structure is obtained. Note that a predetermined number of the cover sheets 54 may be stacked and compressed, and then attached on and under the stacked dielectric green sheets 51.

The side margin section may be formed by attaching a side margin sheet or applied a margin paste to each of the side faces of the multilayer portion. For example, the dielectric green sheets 51, the first patterns 52, and the second patterns 53 are stacked so that the internal electrode layers 12 and the dielectric layers 11 are alternated with each other and the end edges of the internal electrode layers 12 are alternately exposed to both edge faces in the length direction of the dielectric layer 11 so as to be alternately led out to a pair of external electrodes of different polarizations. For example, 6 to 30 first patterns 52 are stacked. During this process, the thickness of the dielectric green sheet 51 between the adjacent first patterns 52 is adjusted so that the ratio of the thickness (the height) of the multilayer chip 10 after firing in the stack direction to the width of the multilayer chip 10 after firing in the shorter side direction becomes 0.7 or less, and the thickness Ta of the capacitance section 14 in the stack direction becomes equal to or greater than 2.2 times at least one of the thicknesses (Tc1 and Tc2) of the cover layers 13 in the stack direction. Specifically, the number of the dielectric green sheets 51 interposed between the adjacent first pattern 52 is adjusted.

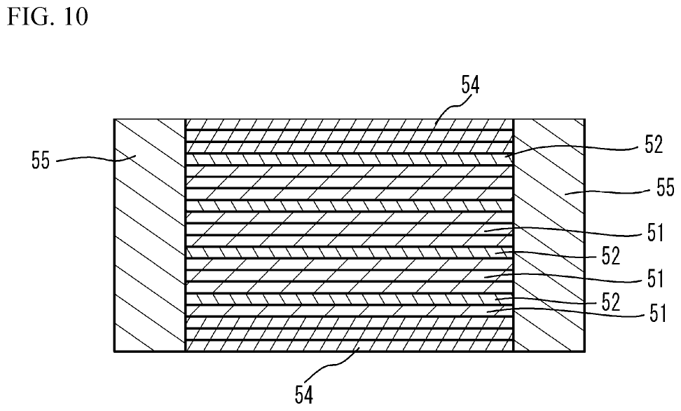

Then, the cover sheets 54, which are to be the cover layers 13, are stacked on and under the stacked dielectric green sheets 51, and then compressed. Thereafter, the resulting multilayer structure is cut into a predetermined size to obtain a multilayer structure having two edge faces to which the patterns of the internal electrode layers 12 are alternately exposed and two side faces to which the patterns of the internal electrode layer 12 are all exposed. Then, as illustrated in FIG. 10, a sheet 55 formed of a side margin paste may be attached to each of the side faces of the multilayer structure or the side margin paste may be applied to each of the side faces of the multilayer structure to form the side margin sections. The margin paste may be used as the side margin paste.

### [Firing (S3)]

A binder is removed from the resulting ceramic multilayer structure in a nitrogen (N₂) atmosphere. Then, a Ni paste to be the base for the external electrodes 20a and 20b is applied by dipping, and fired in a reductive atmosphere with an oxygen partial pressure of 10⁻⁵ to 10⁻⁸ atm in a temperature range of 1100° C. to 1300° C. for 10 minutes to 2 hours.

### [Re-Oxidizing (S4)]

Thereafter, the re-oxidizing process may be performed in a N₂ gas atmosphere in a temperature range of 600° C. to 1000° C.

### [Plating (S5)]

Thereafter, each of the external electrodes 20a and 20b may be coated with a metal such as Cu, Ni, or Sn by plating.

As described above in detail, in the manufacturing method of the present embodiment, the dielectric green sheets 51, the first patterns 52, and the second patterns 53 are stacked so that the internal electrode layers 12 and the dielectric layers 11 are alternated with each other and the end edges of the internal electrode layers 12 are alternately exposed to both edge faces in the length direction of the dielectric layer 11 so as to be alternately led out to a pair of the external electrodes 20a and 20b of different polarizations. The thickness of the dielectric green sheet 51 between the adjacent first patterns 52 is adjusted so that the ratio of the thickness of the multilayer chip 10, which is to be obtained through firing, in the stack direction to the width of the multilayer chip 10 in the shorter side direction becomes 0.7 or less, and the thickness of the capacitance section, in which the adjacent internal electrode layers connected to different external electrodes are opposite to each other, in the stack direction becomes equal to or greater than 2.2 times at least one of the thicknesses of the cover layers in the stack direction. This process inhibits the shapes of the edge faces of the multilayer chip 10 from becoming irregular due to the difference between the shrinkage of the multilayer portion in which the first patterns 52 and the dielectric green sheets 51 are alternately stacked and the shrinkage of the cover sheets 54. Thus, the reliability of the electric connection between the internal electrode layers 12 and the external electrodes 20a and 20b is increased.

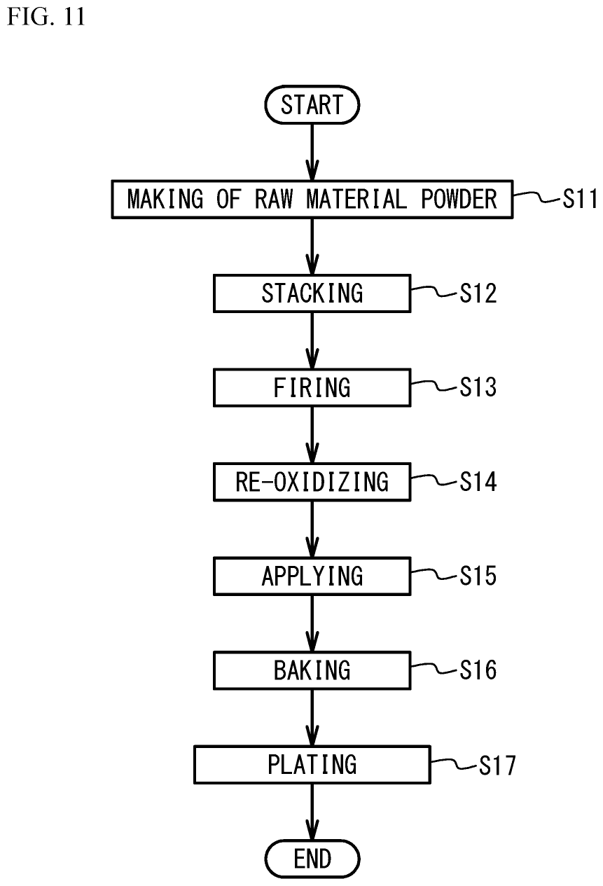

In the above manufacturing method, Ni pastes to be the base for the external electrodes 20a and 20b are applied to the ceramic multilayer structure by dipping and then fired. However, as illustrated in FIG. 11, after firing of the ceramic multilayer structure, metal conductive pastes to be the base for the external electrodes 20a and 20b may be applied to the edge faces of the resulting multilayer chip by dipping, and then baked.

In the above embodiment, the multilayer ceramic capacitor has been described as an example of the ceramic electronic component. However, the ceramic electronic component is not limited to the multilayer ceramic capacitor. For example, the ceramic electronic component may be other electronic components such as a varistor and a thermistor.

### EXAMPLES

The multilayer ceramic capacitor in accordance with the embodiment was fabricated, and the electric connection between the internal electrode layers 12 and the external electrodes 20a and 20b was examined.

Additives were added to barium titanate powder and were sufficiently wet-blended and crushed in a ball mill to obtain a dielectric material. Additives were added to barium titanate powder and were sufficiently wet-blended and crushed in a ball mill to obtain a margin material. Additives were added to barium titanate powder and were sufficiently wet-blended and crushed in a ball mill to obtain a cover material.

An organic binder and solvents were added to the dielectric material, and the dielectric green sheets 51 were made using a doctor blade method. The organic binder was a butyral-based binder. The solvents were toluene and ethyl alcohol. The first pattern 52 of the metal conductive paste was printed on the resulting dielectric green sheet 51. The thickness of the first pattern 52 was 0.8 μm. A predetermined number of the dielectric green sheets 51 on which no first pattern 52 was printed were stacked on the dielectric green sheet 51 on which the first pattern 52 was printed, and another dielectric green sheet 51 on which the first pattern 52 was printed was then stacked so that the positions of the first patterns 52 are alternately shifted. By repeating this process, a multilayer portion in which 16 first patterns 52 were stacked was obtained.

By varying the number of the dielectric green sheets 51 interposed between the first patterns 52, the ratio of the thickness Ta of the capacitance section 14 in the stack direction to at least one of the thicknesses Tc1 and Tc2 of the cover layers 13 in the stack direction was varied. An organic binder and solvents were added to the cover material, and the cover sheets 54 were made using a doctor blade method. The organic binder was a butyral-based binder. The solvents were toluene and ethyl alcohol. Thereafter, the cover sheets 54 were stacked on and under the stacked dielectric green sheets 51, and heated and compressed to make a multilayer structure. The thickness of the cover sheet 54 in the stack direction was adjusted so that the thickness of the multilayer chip 10 in the stack direction was the same between samples.

Thereafter, the multilayer structure was cut into a predetermined chip size. Then, a conductive paste for external electrode containing a metal filler, a glass component, a binder, and solvents was applied to the resulting multilayer structure, dried, and fired to obtain a multilayer chip.

### Examples 1 to 3

As presented in Table 1, in the example 1, the thickness T of the multilayer chip 10 after firing in the stack direction was 110 μm, the thicknesses Tc1 and Tc2 of the cover layers 13 in the stack direction were 26 μm, and the thickness Ta of the capacitance section 14 in the stack direction was 58 μm. The thickness of each internal electrode layer 12 in the stack direction was 0.8 μm, and the thickness of each dielectric layer 11 in the stack direction was 1.0 μm. The width Ws of the side margin section 16 in the facing direction of the two side faces of the multilayer chip 10 was 50 μm, and the width Wi of the internal electrode layer 12 in the facing direction of the two side faces of the multilayer chip 10 was 90 μm. The length Le of the end margin section 15 in the facing direction of the two edge faces of the multilayer chip 10 was 50 μm, and the length Li of the internal electrode layer 12 in the facing direction of the two edge faces of the multilayer chip 10 was 265 μm.

In the example 2, the thickness T of the multilayer chip 10 in the stack direction was 110 μm, the thicknesses Tc1 and Tc2 of the cover layers 13 in the stack direction were 22 μm, and the thickness Ta of the capacitance section 14 in the stack direction was 66 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

In the example 3, the thickness T of the multilayer chip 10 in the stack direction was 110 μm, the thicknesses Tc1 and Tc2 of the cover layers 13 in the stack direction was 20 μm, and the thickness Ta of the capacitance section 14 in the stack direction was 70 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

### Examples 4 to 6

In the example 4, the thickness T of the multilayer chip 10 in the stack direction was 65 μm, the thicknesses Tc1 and Tc2 of the cover layers 13 in the stack direction were 15 μm, and the thickness Ta of the capacitance section 14 in the stack direction was 35 μm. The thickness of each internal electrode layer 12 in the stack direction was 0.8 μm, and the thickness of each dielectric layer 11 in the stack direction was 2.0 μm. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

In the example 5, the thickness T of the multilayer chip 10 in the stack direction was 64 μm, the thicknesses Tc1 and Tc2 of the cover layers 13 in the stack direction were 15 μm and 10 μm, respectively, and the thickness Ta of the capacitance section 14 in the stack direction was 38 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

In the example 6, the thickness T of the multilayer chip 10 in the stack direction was 61 μm, the thicknesses Tc1 and Tc2 of the cover layers 13 in the stack direction were 10 μm, and the thickness Ta of the capacitance section 14 in the stack direction was 41 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

### Comparative Example 1

In the comparative example 1, the thickness T of the multilayer chip 10 in the stack direction was 110 μm, the thicknesses Tc1 and Tc2 of the cover layers 13 in the stack direction were 30 μm, and the thickness Ta of the capacitance section 14 in the stack direction was 50 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

### Comparative Examples 2 and 3

In the comparative example 2, the thickness T of the multilayer chip 10 in the stack direction was 60 μm, the thicknesses Tc1 and Tc2 of the cover layers 13 in the stack direction were 18 μm, and the thickness Ta of the capacitance section 14 in the stack direction was 24 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

In the comparative example 3, the thickness T of the multilayer chip 10 in the stack direction was 60 μm, the thicknesses Tc1 and Tc2 of the cover layers 13 in the stack direction were 20 μm, and the thickness Ta of the capacitance section 14 in the stack direction was 20 μm. The thickness of each internal electrode layer 12 and the thickness of each dielectric layer 11 were the same as those of the example 1, respectively. The width Ws of the side margin section 16 in the facing direction of the two side faces of the multilayer chip 10 and the width Wi of the internal electrode layer 12 in the facing direction of the two side faces of the multilayer chip 10 were the same as those of the example 1, respectively. The length Le of the end margin section 15 in the facing direction of the two edge faces of the multilayer chip 10 and the length Li of the internal electrode layer 12 in the facing direction of the two edge faces of the multilayer chip 10 were the same as those of the example 1, respectively.

TABLE 1

| | T | Tc1 | Tc2 | Ta | Ws | Wi | Le | Li |
|---|---|---|---|---|---|---|---|---|
| | [μm] | [μm] | [μm] | [μm] | [μm] | [μm] | [μm] | [μm] |
| Example 1 | 110 | 26 | 26 | 58 | 50 | 90 | 50 | 265 |
| Example 2 | 110 | 22 | 22 | 66 | 50 | 90 | 50 | 265 |
| Example 3 | 110 | 20 | 20 | 70 | 50 | 90 | 50 | 265 |
| Example 4 | 65 | 15 | 15 | 35 | 50 | 90 | 50 | 265 |
| Example 5 | 64 | 15 | 10 | 38 | 50 | 90 | 50 | 265 |
| Example 6 | 61 | 10 | 10 | 41 | 50 | 90 | 50 | 265 |
| Comparative | 110 | 30 | 30 | 50 | 50 | 90 | 50 | 265 |
| Example 1 | | | | | | | | |
| Comparative | 60 | 18 | 18 | 24 | 50 | 90 | 50 | 265 |
| Example 2 | | | | | | | | |
| Comparative | 60 | 20 | 20 | 20 | 50 | 90 | 50 | 265 |
| Example 3 | | | | | | | | |

### Connection Ratio

The fabricated multilayer ceramic capacitor was polished so that a cross-section orthogonal to the facing direction of the side faces of the multilayer chip at the center part of the multilayer chip could be observed, and the cross-section was then observed using a scanning electron microscope (SEM). The distance D1 between each of the internal electrode layers 12 and the corresponding one of the external electrodes 20a and 20b in the facing direction of the two edge faces of the multilayer chip was measured. When the distance D1 was 1.5 μm or less, the internal electrode layer 12 was determined to be electrically connected to the corresponding external electrode 20a or 20b. The ratio of the number of the internal electrode layers 12 connected to the corresponding external electrode 20a or 20b (the number of the internal electrode layers 12 each having a distance D1 of 1.5 μm or less from the corresponding external electrode 20a or 20b) to the total number of the internal electrode layers 12 was calculated as the connection ratio.

Table 2 lists the results. In the comparative examples 1 to 3, the connection ratios were low, and 60%, 50%, and 30%, respectively. The reason is considered as follows. In the comparative examples 1 to 3, the thickness Ta of the capacitance section 14 in the stack direction was less than 2.2 times the thicknesses Tc1 and Tc2 of the cover layers 13 in the stack direction. Therefore, the difference between the shrinkage of the cover layers 13 and the shrinkage of the capacitance section 14 made the edge faces of the multilayer chip 10 irregular, resulting in decrease in the connection ratio.

In contrast, in the examples 1 to 6, the connection ratios were 80% or greater. The reason is considered as follows. In the examples 1 to 6, the thickness Ta of the capacitance section 14 in the stack direction was equal to or greater than 2.2 times the thicknesses Tc1 and Tc2 of the cover layers 13 in the stack direction. Thus, the edge faces of the multilayer chip 10 was inhibited from becoming irregular due to the difference between the shrinkage of the cover layers 13 and the shrinkage of the capacitance section 14. As described above, it is revealed that the reliability of the electric connection between the internal electrode layers 12 and the external electrodes 20a and 20b is increased by adjusting the thickness Ta of the capacitance section 14 in the stack direction to be equal to or greater than 2.2 times the thicknesses Tc1 and Tc2 of the cover layers 13 in the stack direction.

TABLE 2

| | Ta/Tc1 | Ta/Tc2 | Connection ratio [%] |
|---|---|---|---|
| Example 1 | 2.2 | 2.2 | 80 |
| Example 2 | 3.0 | 3.0 | 83 |
| Example 3 | 3.5 | 3.5 | 85 |
| Example 4 | 2.3 | 2.3 | 80 |
| Example 5 | 2.5 | 3.8 | 83 |
| Example 6 | 4.1 | 4.1 | 85 |
| Comparative Example 1 | 1.7 | 1.7 | 60 |
| Comparative Example 2 | 1.3 | 1.3 | 50 |
| Comparative Example 3 | 1.0 | 1.0 | 30 |

Although the embodiments of the present invention have been described in detail, it is to be understood that the various change, substitutions, and alterations could be made hereto without departing from the spirit and scope of the invention.

What is claimed is:

1. A ceramic electronic component comprising:
a multilayer chip having a substantially parallelepiped shape and including a multilayer structure, which includes dielectric layers and internal electrode layers that are alternately stacked, and cover layers respectively disposed on a top face and a bottom face of the multilayer structure in a first direction in which the dielectric layers and the internal electrode layers are alternately stacked, the dielectric layers being mainly composed of ceramic, the internal electrode layers being formed so as to be alternately exposed to two edge faces opposite to each other of the multilayer structure; and
a pair of external electrodes formed from the respective edge faces to at least one of side faces of the multilayer chip,
wherein a ratio of a thickness of the multilayer chip in the first direction to a width of the multilayer chip in a shorter side direction is 0.7 or less,
wherein a thickness of a capacitance section where adjacent internal electrode layers connected to different external electrodes are opposite to each other in the first direction is equal to or greater than 2.2 times at least one of thicknesses of the cover layers in the first direction.

2. The ceramic electronic component according to claim 1, wherein the thickness of the capacitance section in the first direction is equal to or greater than 2.3 times at least one of the thicknesses of the cover layers in the first direction.

3. The ceramic electronic component according to claim 1, wherein the thickness of the capacitance section in the first direction is equal to or greater than 3.0 times at least one of the thicknesses of the cover layers in the first direction.

4. The ceramic electronic component according to claim 1, wherein the thickness of the capacitance section in the first direction is equal to or greater than 3.5 times at least one of the thicknesses of the cover layers in the first direction.

5. The ceramic electronic component according to claim 1, wherein the number of the internal electrode layers that are stacked per 10 μm of thickness of the capacitance section in the first direction is 1 or greater and 10 or less.

6. The ceramic electronic component according to claim 1, wherein in a cross-section orthogonal to a facing direction of the side faces of the multilayer chip, a ratio of the number of the internal electrode layers each having a distance of 1.5 μm or less from a corresponding one of the external electrodes in a second direction in the cross-section to a total number of the internal electrode layers is 80% or less, the second direction being a direction in which the two edge faces are opposite to each other.

7. The ceramic electronic component according to claim 1, wherein the thickness of the multilayer chip in the first direction is 0.110 mm or less.

8. The ceramic electronic component according to claim 1, wherein the thickness of the multilayer chip in the first direction is 0.06 mm or less.

9. A method of manufacturing a ceramic electronic component, the method comprising:
forming a ceramic multilayer structure having a substantially parallelepiped shape by alternately stacking ceramic dielectric green sheets and conductive pastes for internal electrode layers to form a multilayer portion in which the conductive pastes are alternately exposed to two edge faces opposite to each other of the multilayer portion, and disposing a cover layer on each of top and bottom faces of the multilayer portion in a first direction in which the ceramic dielectric green sheets and the conductive pastes are alternately stacked;
applying a metal paste from each of two edge faces of the ceramic multilayer structure to at least one of side faces of the ceramic multilayer structure; and
firing the metal pastes and the ceramic multilayer structure to form a multilayer chip and a pair of external electrodes formed from respective edge faces of the multilayer chip to at least one of side faces of the multilayer chip, the multilayer chip including a multilayer structure and a cover layer disposed on each of top and bottom faces of the multilayer structure in the first direction, the multilayer structure including dielectric layers and internal electrode layers that are alternately stacked so that the internal electrode layers are alternately exposed to the two edge faces of the multilayer structure,
wherein the forming of the ceramic multilayer structure includes adjusting a thickness of the ceramic dielectric green sheet between adjacent conductive pastes for internal electrode layers so that a ratio of a thickness of the multilayer chip in the first direction to a width of the multilayer chip in a shorter side direction becomes 0.7 or less, and a thickness of a capacitance section where adjacent internal electrode layers connected to different external electrodes are opposite to each other in the first direction becomes equal to or greater than 2.2 times at least one of thicknesses of the cover layers in the first direction.

10. The method according to claim 9, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 2.3 times at least one of the thicknesses of the cover layers in the first direction.

11. The method according to claim 9, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 3.0 times at least one of the thicknesses of the cover layers in the first direction.

12. The method according to claim 9, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 3.5 times at least one of the thicknesses of the cover layers in the first direction.

13. A method of manufacturing a ceramic electronic component, the method comprising:
forming a ceramic multilayer structure having a substantially parallelepiped shape by alternately stacking ceramic dielectric green sheets and conductive pastes for internal electrode layers to form a multilayer portion in which the conductive pastes are alternately exposed to two edge faces opposite to each other of the multilayer portion, and disposing a cover layer on each of top and bottom faces of the multilayer portion in a first direction in which the ceramic dielectric green sheets and the conductive pastes are alternately stacked;
firing the ceramic multilayer structure to form a multilayer chip including a multilayer structure and a cover layer disposed on each of top and bottom faces of the multilayer structure in the first direction, the multilayer structure including dielectric layers and internal electrode layers that are alternately stacked so that the internal electrode layers are alternately exposed to two edge faces opposite to each other of the multilayer chip;
applying a metal paste from each of the two edge faces of the multilayer chip to at least one of side faces of the multilayer chip; and
baking the metal pastes to form a pair of external electrodes,
wherein the forming of the ceramic multilayer structure includes adjusting a thickness of the ceramic dielectric green sheet between adjacent conductive pastes for internal electrode layers so that a ratio of a thickness of the multilayer chip in the first direction to a width of the multilayer chip in a shorter side direction becomes 0.7 or less, and a thickness of a capacitance section where adjacent internal electrode layers connected to different external electrodes are opposite to each other in the first direction becomes equal to or greater than 2.2 times at least one of thicknesses of the cover layers in the first direction.

14. The method according to claim 13, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 2.3 times at least one of the thicknesses of the cover layers in the first direction.

15. The method according to claim 13, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 3.0 times at least one of the thicknesses of the cover layers in the first direction.

16. The method according to claim 13, wherein the forming of the ceramic multilayer structure includes adjusting the thickness of the ceramic dielectric green sheet between the adjacent conductive pastes for internal electrode layers so that the thickness of the capacitance section in the first direction becomes equal to or greater than 3.5 times at least one of the thicknesses of the cover layers in the first direction.

17. The ceramic electronic component according to claim 1, wherein the thickness of the capacitance section in the first direction is equal to or greater than 2.2 times the thickness of each of the cover layers in the first direction.

18. The method according to claim 9, wherein the forming of the ceramic multilayer structure includes adjusting the thickness of the ceramic dielectric green sheet between the adjacent conductive pastes for internal electrode layers so that the thickness of the capacitance section in the first direction is equal to or greater than 2.2 times the thickness of each of the cover layers in the first direction.

19. The method according to claim 13, wherein the forming of the ceramic multilayer structure includes adjusting the thickness of the ceramic dielectric green sheet between the adjacent conductive pastes for internal electrode layers so that the thickness of the capacitance section in the first direction is equal to or greater than 2.2 times the thickness of each of the cover layers in the first direction.
